(19) United States
(12) Patent Application Publication
(10) Pub. No.: US 2003/0112257 A1
(43) Pub. Date: Jun. 19, 2003

(54) Display driving circuits, electrooptic apparatuses, electronic apparatuses, and display driving methods

(76) Inventor: Tsuyoshi Tamura, Nagano-ken (JP)

Correspondence Address: HOGAN & HARTSON L.L.P., 500 S. GRAND AVENUE, SUITE 1900, LOS ANGELES, CA, 90071-2611, US

(21) Appl. No.: 10/302,720

(22) Filed: Nov. 22, 2002

(30) Foreign Application Priority Data
Nov. 29, 2001 (JP) 2001-364412

(51) Int. Cl. G09G 5/10

(52) U.S. Cl. 345/690

(57) ABSTRACT

Display driving circuits that can achieve both a greater number of gradations and a lower power consumption are provided, as well as an electrooptic apparatus, an electronic apparatus, and a display driving method using the same.

### BACKGROUND OF THE INVENTION

The present invention relates to display driving circuits, electrooptic apparatuses, an electronic apparatuses, and display driving methods.

An electrooptic apparatus is now capable of displaying images in richer color gradations by increasing the number of gradations. Known gradation display methods that enable such image display include a Frame Rate Control (FRC) method, and a Pulse Width Modulation (PWM) method.

According to FRC methods, two gradations, display on and display off, are appropriately switched in units of frames across a plurality of frames. This can give greater variations in the chronologically averaged effective values (for example, effective voltages). As a result, two or more gradations can be displayed.

According to PWM methods, the gradation display is performed by driving with pulse widths according to desired gradation values in units of frames.

However, when these gradations are displayed, for example, on a liquid crystal panel, PWM can cause cross-talk problems. As the number of gradations increases, it is necessary to drive with a pulse signal having a frequency that is proportional to the number of gradations. This leads to an increase in the power consumption. In contrast, FRC does not suffer from cross-talk problems. However, a higher frame frequency is necessary to avoid flicker problems.

Thus, in displaying gradations by using PWM or FRC methods, the goals of a greater number of gradations and lower power consumption are generally incompatible with each other. Accordingly, there is a need for display driving circuits and techniques which can allow for a greater number of gradations to be displayed by PWM or FRC methods while simultaneously decreasing power consumption.

### BRIEF DESCRIPTION OF DRAWINGS

The following discussion may be best understood with reference to the various views of the drawings, described in summary below, which form a part of this disclosure.

FIG. 1 schematically shows block diagram of a structure of a liquid crystal apparatus in which a display driving circuit in accordance with embodiments of the present invention are applied.

FIG. 2 shows a signal driver in accordance with embodiments of the present invention.

FIG. 3 shows an illustration to describe a control in changing the frame frequency according to given switching control signals in accordance with the first embodiment.

FIG. 4 shows an example of gradation data and allocation of gradations.

FIG. 5 shows an example of the linearity of gradation characteristic.

FIG. 6 shows an example of jitter levels in the respective gradations.

FIG. 7 shows a block diagram of portions of a structure of the signal driver in accordance with embodiments of the present invention.

FIGS. 8(A) and (B) show explanatory views that describe the operation principle of the gradation pallet circuit.

FIG. 9 shows an example of a gradation pallet allocation for performing displays with 4096 colors.

FIG. 10 shows an example of a gradation pallet allocation for performing displays with 256 colors.

FIGS. 11(A)-(D) show examples of gradation patterns in a 7-frame cycle, 10-frame cycle, 11-frame cycle and 12-frame cycle.

FIGS. 12(A) and (B) illustrate gradation patterns.

FIG. 13 shows an example of a circuit diagram of a decoder and a pre-charge circuit for decoding and outputting gradation patterns in a 12-frame cycle.

FIG. 14 illustrates a block diagram of an example of a signal driver in accordance with embodiments of the present invention.

FIG. 15 shows a block diagram of an example of a portable telephone on which a liquid crystal apparatus is mounted that uses the signal driver.

FIG. 16 shows a flow chart illustrating an example of processing contents in the portable telephone.

FIG. 17 shows a block diagram of a signal driver in accordance with other embodiments of the present invention.

FIG. 18 illustrates a control in changing the clock pulse frequency based on given switching control signals in accordance with other embodiments of the present invention.

FIG. 19 shows a block diagram of a signal driver in accordance with other embodiments of the present invention.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the size of functional units are exaggerated for clarity. Like numbers refer to like elements throughout.

It will be understood that when an element such as a circuit, portion of a circuit, logic unit, line, electrode, input, or output is referred to as being “connected to” another element, it can be directly connected to the other element or intervening elements may also be present. In contrast, when an element is referred to as being “directly connected to” another element, there are no intervening elements present. When an element is referred to as being “adjacent” another element, it can be near the other element but not necessarily independent of the other element. When an element is referred to as being “between” two things, it can be either partly of completely between those two things, but is not necessarily completely and continuously between those two things. The term “adapted to” should be construed to mean “capable of”.

Practice of preferred aspects of the present invention can provide display driving circuits that can achieve both a greater number of gradations while consuming less power. Electrooptic apparatuses, electronic apparatuses, and display driving methods using such display driving circuits are also provided.

Aspects of the present invention can provide display driving circuits that drive signal electrodes of a display panel having a plurality of scanning electrodes and a plurality of signal electrodes mutually crisscrossing one another for displaying gradations by a frame rate control method, the display driving circuit comprising:

a frame frequency conversion circuit that switches a frame frequency to a first or second frequency based on a given switching control signal;

a gradation pattern decoding circuit that successively performs decoding for each frame and outputs a gradation pattern for designating frames that are to be displayed on or displayed off by a frame rate control method according to gradation data based on a frame frequency of the first or second frequency; and

a signal electrode driving circuit that drives the signal electrodes based on the gradation patterns,

wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal; and

the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode.

The display driving circuit can display gradations according to a gradation pattern by a frame rate control method is capable of switching the first mode and the second mode based on a given switching control signal. In the first mode, the number of colors of gradations is switched to a first number of colors, and the frame frequency conversion circuit switches the frame frequency to a first frequency. In the second mode, the number of colors of gradations is switched to a second number of colors that is fewer than the first number of colors, and the frame frequency conversion circuit switches the frame frequency to a second frequency that is lower than the first frequency. As a result, in the first mode, a picture with a high image quality is displayed, and in the second mode, a picture with a lower image quality is displayed. Accordingly, by appropriately switching the first and second modes, the display quality with a greater number of gradations can be maintained while a lower power consumption can be achieved.

Aspects of the present invention can provide display driving circuits that include a first gradation pallet circuit that converts given input gradation data to gradation data of the first number of colors in the first mode, and a second gradation pallet circuit that converts the given input gradation data to gradation data of the second number of colors in the second mode, wherein the gradation pattern decoding circuit can perform decoding and output a gradation pattern based on gradation data that is converted by the first or second gradation pallet circuit.

By using the first and second gradation pallet circuits, gradation data corresponding to input gradation data can be set at will according to the number of colors in the first and second modes. Therefore the linearity of gradation characteristic can be shifted. Accordingly, when the first and second modes can be appropriately switched, gradations can be displayed with an optimum gradation characteristic depending on the number of colors.

Aspects of the present invention can also provide display driving circuits that drive signal electrodes of a display panel having a plurality of scanning electrodes and a plurality of signal electrodes mutually crisscrossing one another for displaying gradations by a pulse width modulation method, the display driving circuit comprising:

a gradation pallet circuit that converts given input gradation data to gradation data having a first number of colors or gradation data having a second number of colors that is fewer than the first number of colors;

a clock pulse frequency conversion circuit that switches a frequency of a clock pulse signal for performing a pulse width modulation to a first or second clock pulse frequency based on a given switching control signal;

a pulse width modulation circuit that generates a pulse width modulation signal having a pulse width corresponding to gradation data output from the gradation pallet circuit, based on the clock pulse signal having a frequency that is converted to the first or second clock pulse frequency; and

a signal electrode driving circuit that drives the signal electrodes using the pulse width modulation signal,

wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal; and

the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode.

Display driving circuits that display gradations by a pulse width modulation method are capable of switching the first mode and the second mode based on a given switching control signal. In the first mode, the number of colors of gradations is switched to a first number of colors, and the clock pulse frequency conversion circuit switches the frequency of the clock pulse signal for performing a pulse width modulation to a first clock pulse frequency. In the second mode, the number of colors of gradations is switched to a second number of colors that is fewer than the first number of colors, and the clock pulse frequency conversion circuit switches the frequency of the clock pulse signal for performing a pulse width modulation to a second clock pulse frequency that is lower than the first clock pulse frequency. As a result, in the first mode, a picture with a high image quality is displayed, and in the second mode, a picture with a lower image quality is displayed. Accordingly, by appropriately switching the first and second modes, the display quality with a greater number of gradations can be maintained while a lower power consumption can be achieved.

Aspects of the present invention can also provide electrooptic apparatuses including pixels that are specified by a plurality of scanning electrodes and a plurality of signal electrodes mutually crisscrossing one another; any one of the display driving circuits described above that drives the signal electrodes; and a scanning driver that drives the scanning electrodes.

Aspects of the present invention can provide electrooptic apparatuses in which the display quality with a greater number of gradations can be maintained while a lower power consumption can be achieved.

Aspects of the present invention can also provide electrooptic apparatuses including a display panel including pixels that are specified by a plurality of scanning electrodes and a plurality of signal electrodes mutually crisscrossing one another; any one of the display driving circuit described above that drives the signal electrodes; and a scanning driver that drives the scanning electrodes.

Aspects of the present invention can provide electrooptic apparatuses in which the display quality with a greater number of gradations can be maintained while a lower power consumption can be achieved.

Aspects of the present invention can provide electronic apparatuses including:

an operation input section for inputting operation information;

an input presence/absence detection section that detects whether operation information is input from the operation input section;

a gradation data generation section that generates input gradation data based on the operation information that is input from the operation input section;

an electrooptic apparatus recited above that displays gradations based on the input gradation data; and

a mode setting section that sets a first mode or a second mode for the electrooptic apparatus based on a detection result of the input presence/absence detection section,

wherein the mode setting section sets the first mode when the input presence/absence detection section detects an input of the operation information, and switches from the first mode to the second mode when the input presence/absence detection section does not detect an input of the operation information for a predetermined period.

Aspects of the present invention can provide electronic apparatuses that are equipped with the operation input section and the electrooptic apparatus described above. When there is an input of operation information from the operation input section, the first mode is set, and where there is not an input of operation information from the operation input section for a predetermined period, the first mode is switched to the second mode. Therefore, when there is an input of operation information, a picture with a high image quality is displayed on the premise that the user views the picture to be displayed. When there is not an input of operation information for a predetermined period, a picture with a lower image quality is displayed on the premise that the user does not view the picture. As a result, there can be provided an electronic apparatus that displays a picture that is easy to be viewed by the user and that effectively uses the power.

Other aspects of the present invention can also provide display driving methods that drive signal electrodes of a display panel having a plurality of scanning electrodes and a plurality of signal electrodes mutually crisscrossing one another for displaying gradations by a frame rate control method. Such display driving methods can comprise:

performing decoding and outputting a gradation pattern for designating frames that are to be displayed on or displayed off by a frame rate control method according to gradation data having a first number of colors in a first mode that is set based on a given switching control signal, and performing decoding and outputting a gradation pattern according to gradation data having a second number of colors that is fewer than the first number of colors in a second mode that is set based on the switching control signal;

switching the frame frequency from a first frequency to a second frequency that is lower than the first frequency when the first mode is switched to the second mode, and switching the frame frequency from the second frequency to the first frequency when the second mode is switched to the first mode; and

driving the signal electrodes at the first or second frequency, based on the gradation patterns decoded and output with the frame frequency having the first or second frequency.

When gradations are displayed according to a gradation pattern by a frame rate control method, the first and second modes can be switched based on a given switching control signal. In the first mode, the number of colors of gradations is switched to a first number of colors, and the frame frequency is switched to a first frequency. In the second mode, the number of colors of gradations is switched to a second number of colors that is fewer than the first number of colors, and the frame frequency is switched to a second frequency that is lower than the first frequency. As a result, in the first mode, a picture with a high image quality is displayed, and in the second mode, a picture with a lower image quality is displayed. Accordingly, by appropriately switching the first and second modes, the display quality with a greater number of gradations can be maintained while a lower power consumption can be achieved.

Aspects of the present invention can provide display driving methods for displaying gradations by a frame rate control method for a display panel having a plurality of scanning electrodes and a plurality of signal electrodes mutually crisscrossing one another. Such display driving methods can include: changing a frame frequency for displaying gradations by a frame rate control method according to a changeable number of colors of gradations; and displaying gradations using the changed frame frequency.

An optimum number of colors and a frame frequency corresponding to the same are controlled, such that the gradation display by the frame rate control method can be optimized in view of the display quality and further in view of the power consumption.

Also, such methods can allow, when the number of colors is a first number of colors, the frame frequency to be set to a first frequency, and when the number of colors is a second number of colors that is fewer than the first number of colors, the frame frequency to be set to a second frequency that is lower than the first frequency.

Thus, when gradients are displayed by a frame rate control method, a greater number of gradients and a lower power consumption can both be achieved.

Aspects of the present invention can provide display driving methods that drive signal electrodes of a display panel having a plurality of scanning electrodes and a plurality of signal electrodes mutually crisscrossing one another for displaying gradations by a pulse width modulation method. Such display driving methods can include:

converting given input gradation data to gradation data having a first number of colors in a first mode that is set based on a given switching control signal, and converting the input gradation data to gradation data having a second number of colors that is fewer than the first number of colors in a second mode that is set based on the switching control signal;

switching the frequency of the clock pulse signal from a first clock pulse frequency to a second clock pulse frequency that is lower than the first clock pulse frequency when the first mode is switched to the second mode, and switching the frequency of the clock pulse signal from the second clock pulse frequency to the first clock pulse frequency when the second mode is switched to the first mode;

generating a pulse width modulation signal having a pulse width corresponding to gradation data having the first or second number of colors, based on the clock pulse signal having a frequency that is converted to the first or second clock pulse frequency; and

driving the signal electrodes using the pulse width modulation signal.

Thus, when gradations are displayed by a pulse width modulation method, the first and second modes can be switched based on a given switching control signal. In the first mode, the number of colors of gradations is switched to a first number of colors, and the frequency of the clock pulse signal for performing a pulse width modulation is switched to a first clock pulse frequency. In the second mode, the number of colors of gradations is switched to a second number of colors that is fewer than the first number of colors, and the frequency of the clock pulse signal for performing a pulse width modulation is switched to a second clock pulse frequency that is lower than the first clock pulse frequency. As a result, in the first mode, a picture with a high image quality is displayed, and in the second mode, a picture with a lower image quality is displayed. Accordingly, by appropriately switching the first and second modes, the display quality with a greater number of gradations can be maintained while a lower power consumption can be achieved.

Aspects of the present invention can also provide display driving methods for displaying gradations by a pulse width modulation method for a display panel having a plurality of scanning electrodes and a plurality of signal electrodes mutually crisscrossing one another, the display driving method including: changing a frequency of a clock pulse signal for generating a pulse width modulation signal according to a changeable number of color for gradations; and displaying gradations using the changed frequency of the clock pulse signal.

Accordingly, an optimum number of colors and a clock pulse frequency corresponding to the same are controlled, such that the gradation display by the pulse width modulation method can be optimized in view of the display quality and in view of the power consumption.

Also, when the number of colors is a first number of colors, the clock pulse frequency of the clock pulse signal can be set at a first clock pulse frequency, and when the number of colors is a second number of colors that is fewer than the first number of colors, the clock pulse frequency of the clock pulse signal can be set at a second clock pulse frequency that is lower than the first clock pulse frequency.

When gradients are displayed by a pulse width modulation method, a greater number of gradients and a lower power consumption can both be achieved.

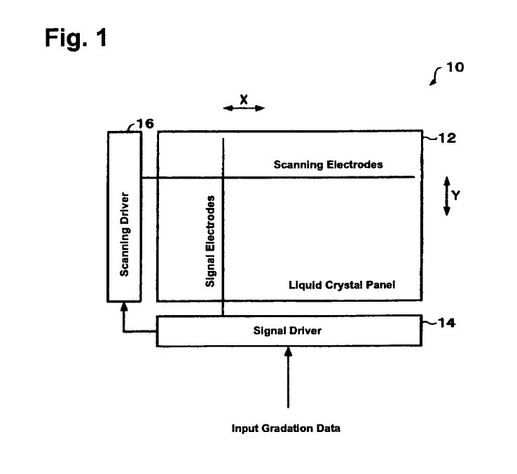

Specific embodiments will now be described with reference to FIGS. 1-16 and 17-19.

1.1 Electrooptic Apparatus

FIG. 1 schematically shows a structure of a liquid crystal apparatus in which a display driving circuit is applied.

An electrooptic apparatus or a display apparatus such as a liquid crystal apparatus 10 may include a display panel such as a liquid crystal panel 12.

The liquid crystal panel 12 is provided with pixels having electrooptic elements such as liquid crystal elements, retained in crossing regions between signal electrodes and scanning electrodes. Each of the pixels is specified by the signal electrode and the scanning electrode. The liquid crystal panel 12 may be anything that uses liquid crystal or any other electrooptic elements which change its own optical property by application of a voltage. In this case, the liquid crystal panel 12 has the following structure. Liquid crystal is sealed between a first substrate in which signal (segment) electrodes are formed and a second substrate in which scanning (common) electrodes are formed. The plurality of the signal electrodes are arranged in a direction X on the first substrate. The plurality of the scanning electrodes are arranged in a direction Y on the second substrate.

The liquid crystal apparatus 10 may include a signal driver 14 that drives the plurality of signal electrodes of the liquid crystal panel 12. The display driving circuit may be used as the signal driver 14 in this embodiment. Further, the liquid crystal apparatus 10 may include a scanning driver (common driver) 16 that drives the plurality of scanning electrodes of the liquid crystal panel 12.

The liquid crystal panel 12 may be mounted, for example, on a glass substrate, and the signal driver 14 or the scanning driver 14, or both of them can be provided on the glass substrate.

Driving voltages for the signal electrodes that are to be driven by the signal driver 14 are generated by a power supply circuit (not shown in the drawings). The power supply circuit is capable of generating voltages to be supplied to the scanning driver 16, and the scanning driver 16 uses the voltages supplied form the power supply to drive the scanning electrodes. The power supply circuit may be built in the signal driver 14 or the scanning driver 16.

The liquid crystal panel 12 can be driven for display by a multiple line driving method (MLS) that simultaneously selects a plurality of scanning electrodes. When the number of simultaneously selected lines is m (m is a natural number, which is, for example, m=4), the scanning driver 16 scans the scanning electrodes in units of m lines. The signal driver outputs to the signal electrodes voltages in a segment waveform (i.e., signal electrode driving waveform, or SEG waveform) based on a display pattern in units of n (n is a natural number, which is, for example n=4 when m=4) lines. The segment waveform is specified by the result of an MLS operation that is performed for the display pattern using an orthogonal function that corresponds to the scanning pattern of the scanning electrodes.

The liquid crystal apparatus 10 thus structured can perform a gradation display by FRC using the signal driver 14. The signal driver 14 drives the signal electrodes while appropriately switching in units of frames across a plurality of frames according to a gradation pattern. The gradation pattern is based on input gradation data provided from an external central processing apparatus or a Central Processing Unit (CPU).

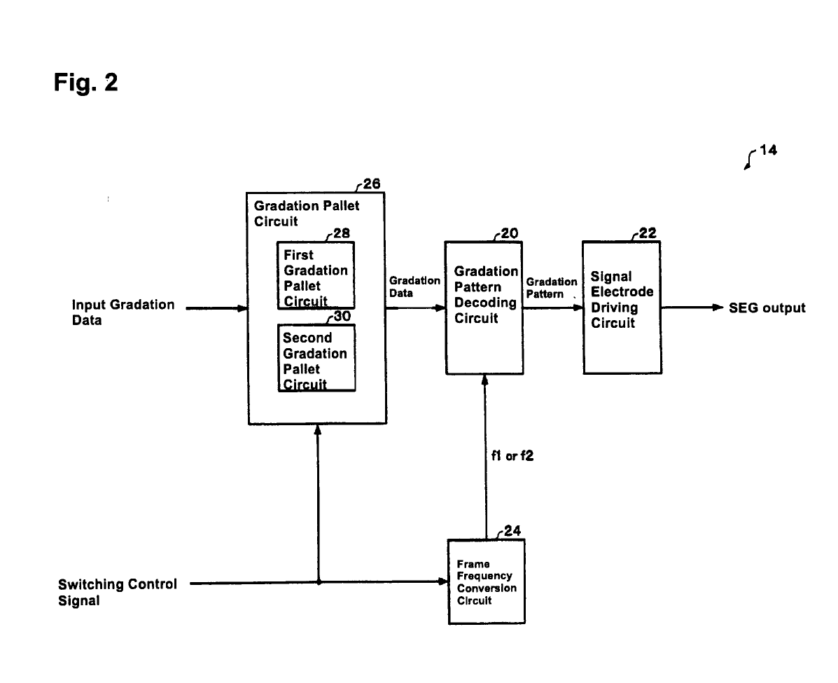

The structure of the signal driver 14 will be described below with reference to FIG. 2.

1.2 Display Driving Circuit (Signal Driver)

FIG. 2 shows the signal driver.

The signal driver 14 can include a gradation pattern decoding circuit 20 and a signal electrode driving circuit 22. The gradation pattern decoding circuit 20 performs decoding and outputs gradation patterns based on gradations corresponding to gradation data. A gradation pattern is data that designates frames to be displayed on or displayed off in units of frames across a plurality of frames for performing a gradation display by FRC. Accordingly, for a given frame frequency, by switching two or more gradations in units of frames according to the gradation pattern, chronologically averaged effective voltages have more variations. As a result, a display of two or more gradations can be performed. The signal electrode driving circuit 22 can then drive the signal electrodes based on the decoded gradation pattern that has been output.

The signal driver 14 may include a frame frequency conversion circuit 24. The frame frequency conversion circuit 24 is capable of switching the frame frequency to a first frequency f1 [Hz] or a second frequency f2 [Hz] (f1>f2) according to a given switching control signal. This type of frame frequency conversion circuit 24 can be realized by, for example, a divider circuit. A circuit that converts to the first or second frequency by changing the dividing ratio can thus be readily composed. The gradation pattern decoding circuit 20 performs decoding and outputs gradation patterns based on a frame frequency of the first or second frequency that has been converted by the frame frequency conversion circuit 24.

Also, the signal driver 14 may include a gradation pallet circuit 26. The gradation pallet circuit 26 is capable of generating gradation data with the number of gradations that is different from the number of gradations of input gradation data. The input gradation data is supplied from, for example, an external CPU. The gradation data that is generated by the gradation pallet circuit 26 is supplied to the gradation pattern decoding circuit 20.

Accordingly, the gradation pallet circuit 26 can assign desired gradation data to the input gradation data to thereby change the linearity of the gradation characteristic and the number of colors.

The gradation pallet circuit 26 can convert the input gradation data into arbitrary gradation data having a first number or a second number of colors (the first number of colors>the second number of colors) based on the switching control signal described above. For this, the gradation pallet circuit 26 includes first and second gradation pallet circuits 28 and 30. The first gradation pallet circuit 28 converts the input gradation data into gradation data having the first number of colors corresponding to the input gradation data. The second gradation pallet circuit 30 converts the input gradation data into gradation data having the second number of colors corresponding to the input gradation data.

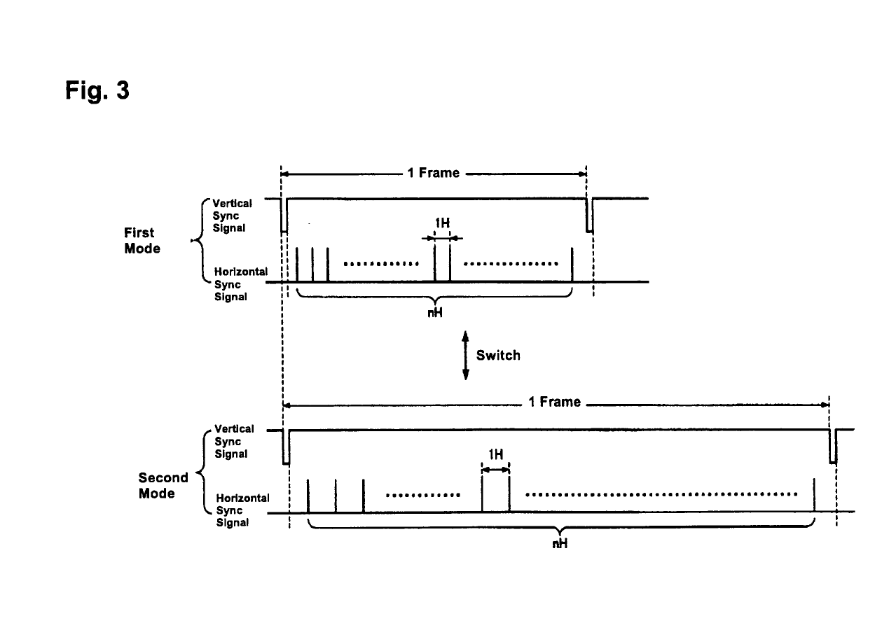

Since the signal driver 14 is equipped with the frame frequency conversion circuit 24 and the gradation pallet circuit 26, it can change the frame frequency according to the number of colors of gradations in accordance with given switching control signals as indicated, for example, in FIG. 3.

For purposes of illustration, a first mode will be defined as when the number of colors is switched to the first number of colors by the switching control signal. A second mode will be defined as when the number of colors is switched to the second number of colors. The switching control signal can be set by, for example, an external CPU.

In the example below, when the gradation display by FRC is performed, for example, 32 gradations can be assigned.

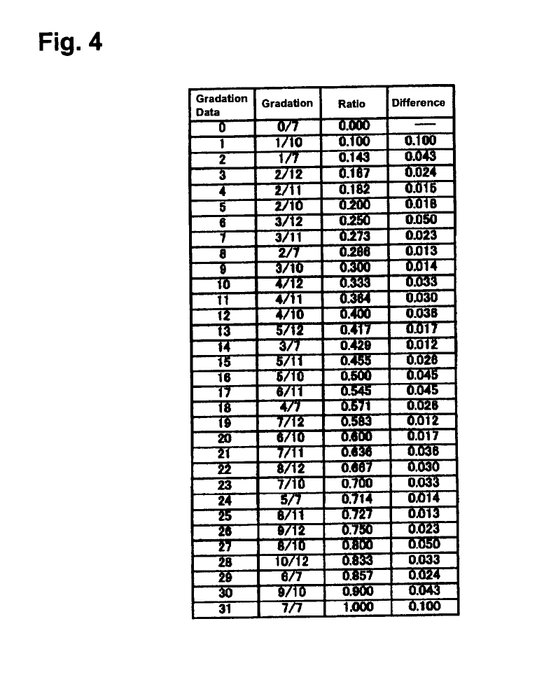

As indicated in FIG. 4, a gradation pattern is allocated to each of the gradations. Gradation patterns are set for four kinds of mutually different frame cycles, i.e., 7 frames, 10 frames, 11 frames and 12 frames. Any one of the gradation patterns, which designate frames to be displayed on or displayed off in unit of frames, can be selected.

For example, the gradation “2/12” corresponding to the gradation data “3” means a gradation pattern in which two of 12 frames in one cycle are displayed on.

Therefore, when 32 gradations are expressed by gradation data in 5 bits, the gradation pattern decoding circuit 20, in response to gradation data “00011” (=“3”), performs decoding in units of frames and successively outputs a gradation pattern corresponding to the gradation “2/12”.

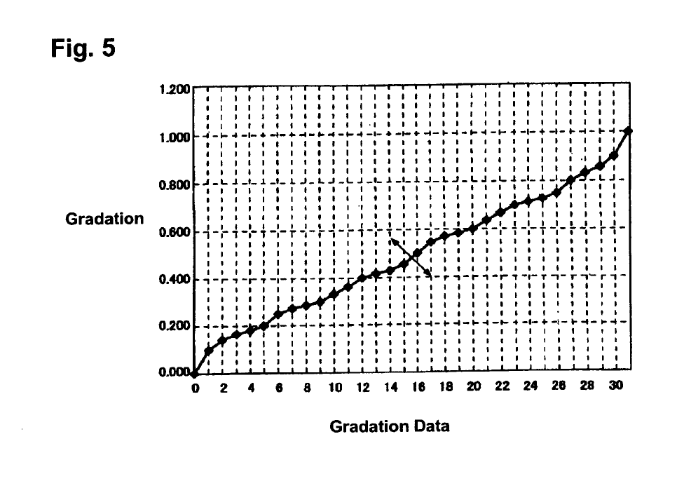

The gradation characteristic representing the relation between the gradation data thus allocated and gradations has a linearity as indicated in FIG. 5.

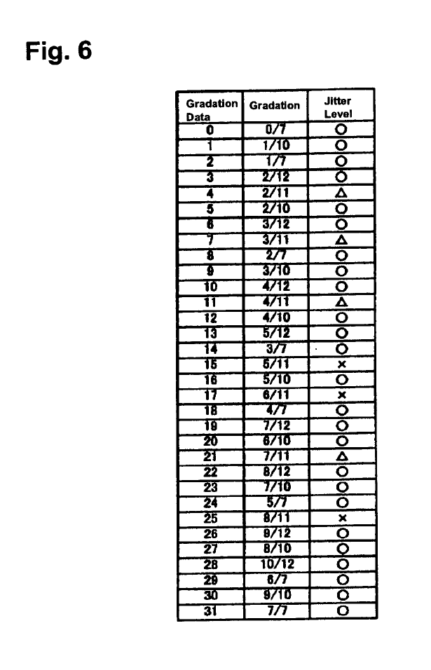

However, when the gradations are actually displayed on a liquid crystal panel according to such a gradation characteristic, the jitters may reach a high level depending on the gradations. This results in a faded picture as perceived by human eyes. For example, as indicated in FIG. 6, the gradations that correspond to the gradation data “15”, “17” and “25” cause high jitter levels. In this case, the frame frequency may be increased to a high level to lower the jitter levels. This, however, can result in a greater power consumption.

With FRC, the number of colors of gradations needs to be increased in order to improve the display quality. The frame frequency also needs to be increased accordingly. However, this would result in an increase in the power consumption. To lower the power consumption, the frame frequency needs to be lowered. However, this leads to an incompatibility, and the problem of flickers.

In view of these difficulties, the signal driver 14 is equipped with a device that switches the frame frequencies. The frame frequencies are switched according to the number of colors in gradations through discriminating in FRC the case when a high quality image display is performed from the case when a lower quality image display is performed.

For example, the first mode may be a display mode with a high image quality based on gradation data having a first number of colors with the frame frequency being a first frequency f1. The second mode may be display mode with a lower image quality based on gradation data having a second number of colors with the frame frequency being a second frequency f2 that is lower than the first frequency.

The jitter levels of specific gradations may become high depending on the frame frequencies. Accordingly, when the number of colors in gradations are changed, the display quality may lower if the gradation patterns that are used in the other mode are used. Thus, the signal driver 14 has the gradation pallet circuit 26 as a device that shifts the linearity of the gradation characteristic, whereby the one with a lower jitter level can be selected and set for each of the gradations.

With the structure described above, and by appropriately switching the first and second modes, cases in which pictures with a high image quality (and that are excellent in the reproducibility) are to be displayed may be discriminated from cases in which such high image quality is not required. As such, the number of colors in gradations is appropriately changed. The linearity of the gradation characteristic indicated in FIG. 5 can be shifted to switch to a frame frequency that is optimum to each of the respective numbers of colors. Thus, the display quality can be maintained and the power consumption can be lowered.

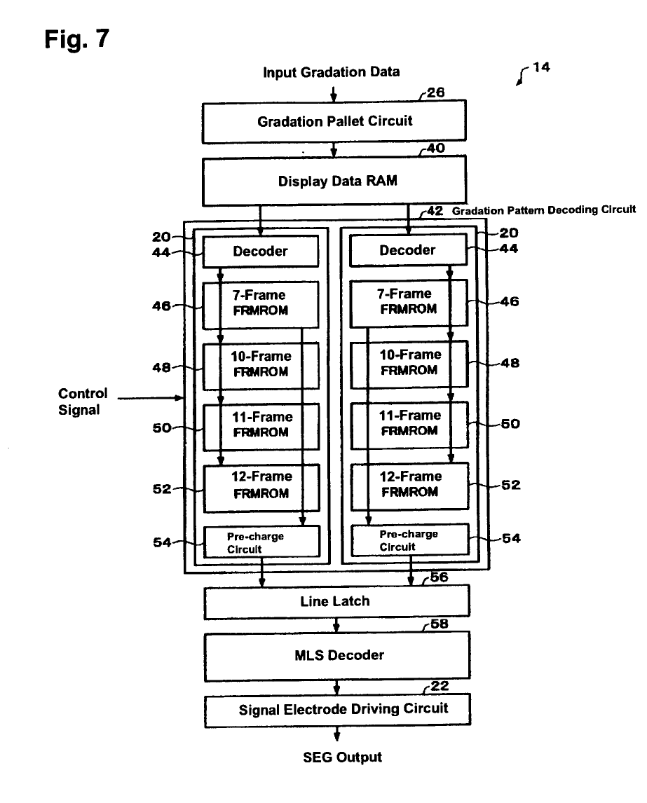

FIG. 7 shows portions of the signal driver. The figure shows a block structure for one segment output.

In the signal driver 14, the gradation pallet circuit 26 converts input gradation data in a (a is a natural number) bits that is supplied from, for example, an external CPU to gradation data in b (b is a natural number) bits. Here, it is assumed that the input gradation data is converted to gradation data in 5 (b=5) bits. The gradation data in b bits is gradation data that is set in advance by the CPU or the like.

The gradation data generated by the gradation pallet circuit 26 is input in a display data RAM 40. The display data RAM 40 stores this gradation data in 5 bits, which is read out in units of 2 scanning lines.

The gradation data that is read out from the display data RAM 40 in units of 2 scanning lines is input in a gradation decoding circuit 42 that includes the gradation pattern decoding circuit 20.

The gradation decoding circuit 42 successively performs decoding and outputs, in units of frames, gradation patterns for 4 kinds of frame cycles. For this purpose, the gradation pattern decoding circuit 20 included in the gradation decoding circuit 42 includes decoders 44, frame ROMs 46, 48, 50 and 52, and pre-charge circuits 54.

The decoder 44 is a circuit that performs decoding to determine which one of the gradation patterns, in which one of the frame cycles, is to be used based on the gradation data read out the display data RAM 40.

The frame ROM 46 is a decoding circuit. This decoding circuit performs decoding and outputs a gradation pattern that designates display-on and display off in units of frames in the 7-frame cycle, and may be composed of a ROM.

The frame ROM 48 is a decoding circuit. This decoding circuit performs decoding and outputs a gradation pattern that designates display-on and display off in units of frames in the 10-frame cycle, and may be composed of a ROM.

The frame ROM 48 is a decoding circuit. This decoding circuit performs decoding and outputs a gradation pattern that designates display-on and display-off in units of frames in the 10-frame cycle, and may be composed of a ROM.

The frame ROM 52 is a decoding circuit. This decoding circuit performs decoding and outputs a gradation pattern that designates display-on and display-off in units of frames in the 12-frame cycle, and may be composed of a ROM.

The pre-charge circuit 54 is a circuit that pre-charges signal lines in order to read out the decoded result provided by the frame ROMs 46, 48, 50 or 52.

The gradation pattern output from the gradation decoding circuit 42 is latched at a line latch 56. The latched gradation pattern for 2 scanning lines are input in an MLS decoder 58 in units of the number of lines to be simultaneously selected in the MLS decoder.

The MLS decoder 58 performs decoding, and outputs, based on the gradation pattern input from the line latch 56, the result of an MLS operation corresponding to a scanning pattern of 4 scanning lines that are simultaneously selected. For example, by using an orthogonal function based on the scanning pattern, an MLS operation is performed for the gradation pattern corresponding to the scanning pattern, and its result is output.

The signal electrode driving circuit 22 drives the signal electrodes based on the MLS operation result provided from the MLS decoder 58.

The circuit described above will now be explained below in greater detail.

1.2.1 Gradation Pallet Circuit

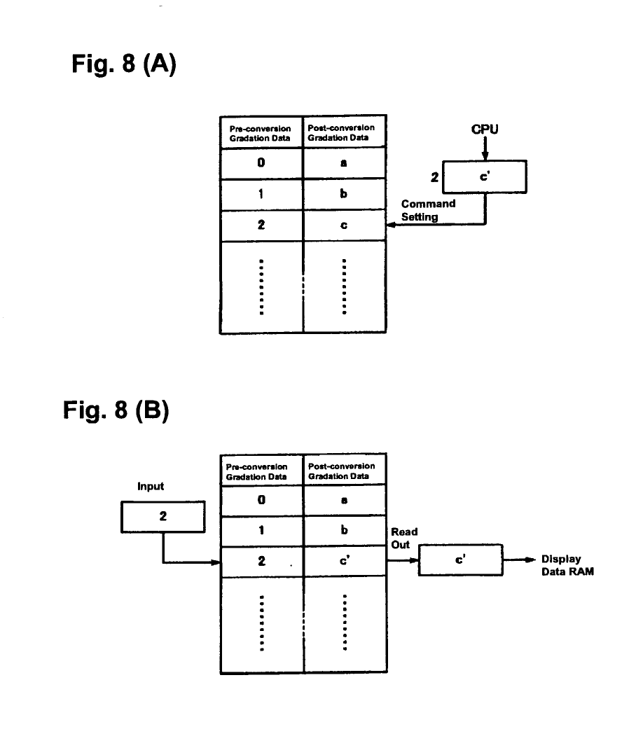

FIGS. 8(A) and (B) illustrate operation principles of the gradation pallet circuit 26.

The gradation pallet circuit 26 can set 4096 kinds of gradations by the first gradation pallet circuit 28, or 256 kinds of gradations by the second gradation pallet circuit 30 among about 32,000 colors (2⁵)³ that are determined by 5-bit gradation data provided for each color (R, G, B). Accordingly, by setting post-conversion gradation data for pre-conversion gradation data that are input as input gradation data, any gradations can be allocated to the input gradation data. For example, as indicated in FIG. 8 (A), by a command of the CPU, post-conversion gradation data “c” for the pre-conversion gradation data “2” may be replaced with “c′”. Thereafter, as indicated in FIG. 8 (B), when input gradation data “2” is input, the post-conversion gradation data “c′” corresponding to the input gradation data “2” is read out.

With this structure, the gradation pallet circuit 26 can select and set gradations corresponding to input gradation data from about 32,000 colors in a manner to shift the linearity of the gradation characteristic, and output the same as 5-bit gradation data. As a result, the linearity of the gradation characteristic can be shifted.

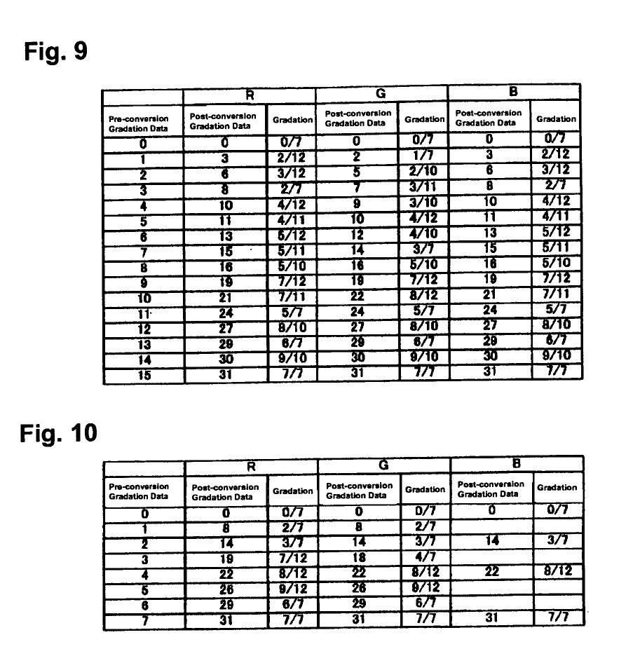

FIG. 9 shows the allocation of gradations when a display with 4096 colors is performed. The allocation of gradations is performed by the first gradation pallet circuit 28. When input gradation data as pre-conversion gradation data is input, the first gradation pallet circuit 28 outputs post-conversion gradation data that are set in advance for each of R, G and B. For example, when the pre-conversion gradation data is “6”, post-conversion gradation data “13” among the gradation data for 32 gradations shown in FIG. 4 in the case of R, post-conversion gradation data “12” in the case of G, and post-conversion gradation data “13” in the case of B are output. The post-conversion gradation data are input in the gradation pattern decoding circuit 20. The gradation pattern decoding circuit 20 performs decoding and outputs a gradation pattern corresponding to the input gradation data. For example, when the post-conversion gradation data is “13”, it performs decoding and outputs a gradation pattern corresponding to the gradation “5/12”.

In this manner, the gradation characteristic is optimized for each of the colors R, G and B, and a display of gradations with 4096 (=16³) colors is realized.

FIG. 10 shows the allocation of gradations when a display with 256 colors is performed. This allocation of gradations is performed by the second gradation pallet circuit 30. When input gradation data as pre-conversion gradation data is input, the second gradation pallet circuit 30 outputs post-conversion gradation data that are set in advance for each of R, G and B. For example, when the pre-conversion gradation data is “4”, post-conversion gradation data “22” among the gradation data for 32 gradations shown in FIG. 4 in the case of R, post-conversion gradation data “22” in the case of G, and post-conversion gradation data “22” in the case of B are output. The post-conversion gradation data are input in the gradation pattern decoding circuit 20. The gradation pattern decoding circuit 20 performs decoding and outputs a gradation pattern corresponding to the input gradation data. For example, when the post-conversion gradation data is “22”, it performs decoding and outputs a gradation pattern corresponding to the gradation “8/12”.

In this manner, the gradation characteristic is optimized for each of the colors R, G and B, and a display of gradations with 256 (=8×8×4) colors is realized.

1.2.2 Gradation Decoding Circuit

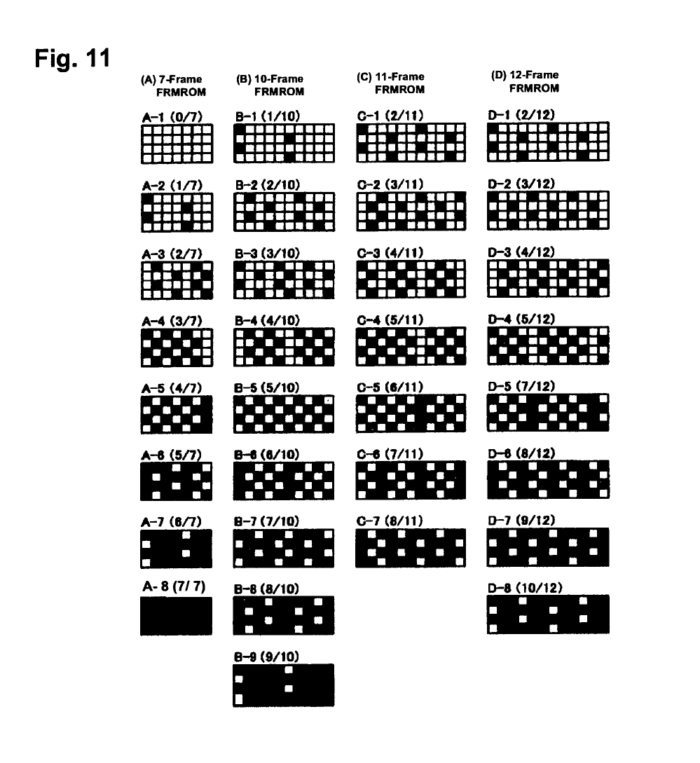

FIGS. 11(A)-(D) show examples of gradation patterns that are decoded and output by the frame ROMs 46, 48, 50 and 52. Here, the figures show gradation patterns used when performing an MLS operation that simultaneously selects 4 lines.

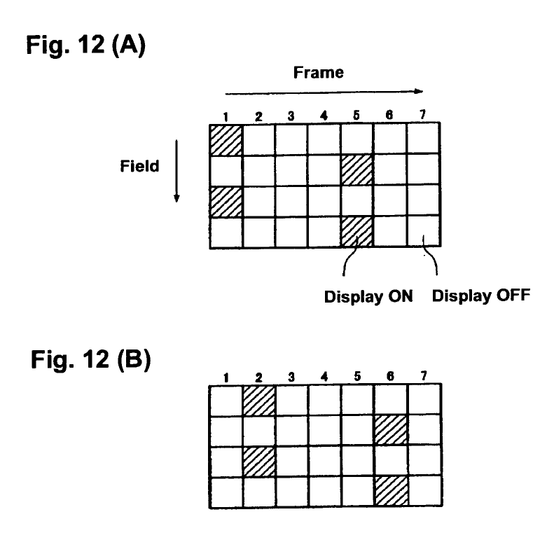

The frame ROM 46 decodes and outputs any one of 8 kinds of gradation patterns corresponding to the gradations “0/7”-“7/7”, as shown in FIG. 11 (A). Each of the gradation patterns is data that represents display-on or display-off of each of the frames in the 7-frame cycle. For example, a gradation pattern corresponding to the gradation “1/7” designates that only one of the seven frames be displayed on as shown in FIG. 12 (A).

Similarly, the frame ROM 48 decodes and outputs any one of 9 kinds of gradation patterns corresponding to the gradations “1/10”-“9/10” as shown in FIG. 11 (B). Each of the gradation patterns is data that represents display-on or display-off of each of the frames in the 10-frame cycle.

The frame ROM 50 decodes and outputs any one of 7 kinds of gradation patterns corresponding to the gradations “2/11”-“8/11” as shown in FIG. 11 (C). Each of the gradation patterns is data that represents display-on or display-off of each of the frames in the 11-frame cycle.

Similarly, the frame ROM 52 decodes and outputs any one of 8 kinds of gradation patterns corresponding to the gradations “2/12”-“10/12” as shown in FIG. 11 (D). Each of the gradation patterns is data that represents display-on or display-off of each of the frames in the 12-frame cycle.

These gradation patterns may preferably be set as follows so as not to be perceived by the human eyes as given patterns. As shown in FIG. 12 (B), a frame ROM for adjacent segments may set a pattern which is shifted by one frame compared to the gradation pattern shown in FIG. 12 (A). Thus, each of the signal electrodes may preferably output decoded gradation patterns that are shifted at each output.

In the gradation pattern decoding circuit 20, the decoder 44 selects a frame ROM to be used according to the gradations corresponding to the gradation data. The selected frame ROM outputs a gradation pattern corresponding to the frames in response to a control signal provided from a display control circuit (not shown in the drawings) to signal lines that are pre-charged by the pre-charge circuit 54. The control signal may be a frame signal that indicates the number of frames to be changed by, for example, a frame frequency f1 or f2.

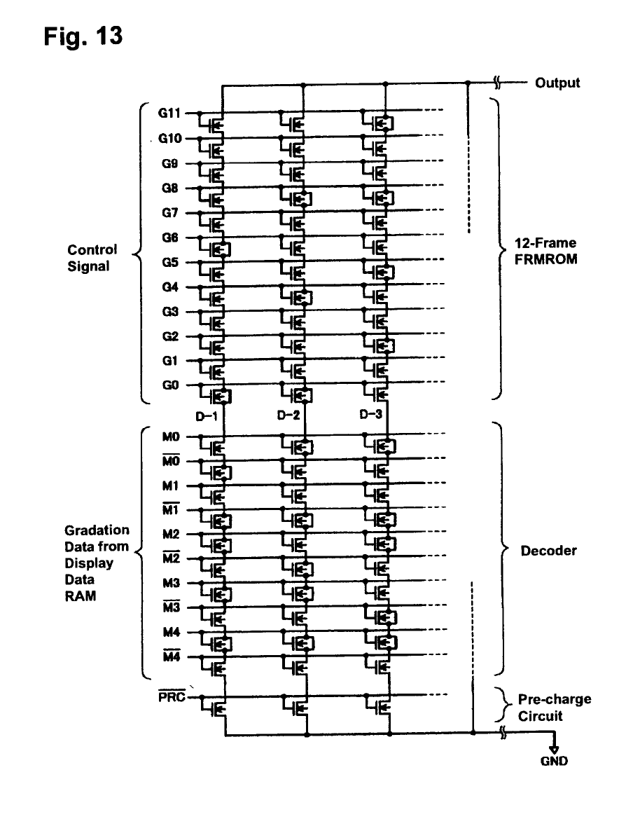

FIG. 13 shows a 12-frame FRMROM, the decoder and the pre-charge circuit. One possible example implements a 12-frame FRMROM, however a 7-frame FRMROM, a 10-frame FRMROM and an 11-frame FRMROM could also be implemented in a similar manner.

FIG. 13 shows only a portion among the 12-frame FRMROM, which decodes gradation patterns corresponding to the gradations “2/12”, “3/12” and “4/12”. Since the decoding principle is the same for each of the gradation patterns, a gradation pattern that corresponds to the gradation “2/12” will be described below.

Between an output signal line and a ground power supply potential GND, the 12-frame FRMROM that decodes and outputs a gradation pattern for the frames among gradation patterns corresponding to the gradation “2/12”, the decoder that decodes the gradation data read out from the display data RAM, and n-type MOS transistors that compose the pre-charge circuit for pre-charging the output signal line are serially connected.

For example, when a gradation pattern corresponding to the gradation “2/12” is decoded and output, the decoder has the pre-charge circuit outputs a pre-charge potential when 5-bit gradation data (M4, . . . , M0) defines “3” (=(0, 0, 0, 1, 1)). For this reason, drain terminals and source terminals of n-type MOS transistors, at which signals are applied to their gate electrodes corresponding to bits M4, M3 and M2 of the gradation data, can be electrically connected via aluminum wirings or the like. Drain terminals and source terminals of n-type MOS transistors, at which signals are applied to their gate electrodes corresponding to bits /M1 and /M0 of the gradation data, can also be electrically connected via aluminum wirings or the like.

Control signals G0-G11 are input in the 12-frame FRMROM as frame signals that are respectively indicative of the corresponding frames. Each of the 12 frames is specified by each of the corresponding control signals G0-G11. Therefore, drain terminals and source terminals of the n-type MOS transistors, at which the control signals G0 and G6 indicative of the first frame and the seventh frame among the 12 frames are applied to their gate electrodes, can be electrically connected via aluminum wirings or the like. By so doing, the pre-charge potential output from the decoder can be transferred to the output signal line at the first frame and the seventh frame among the 12 frames.

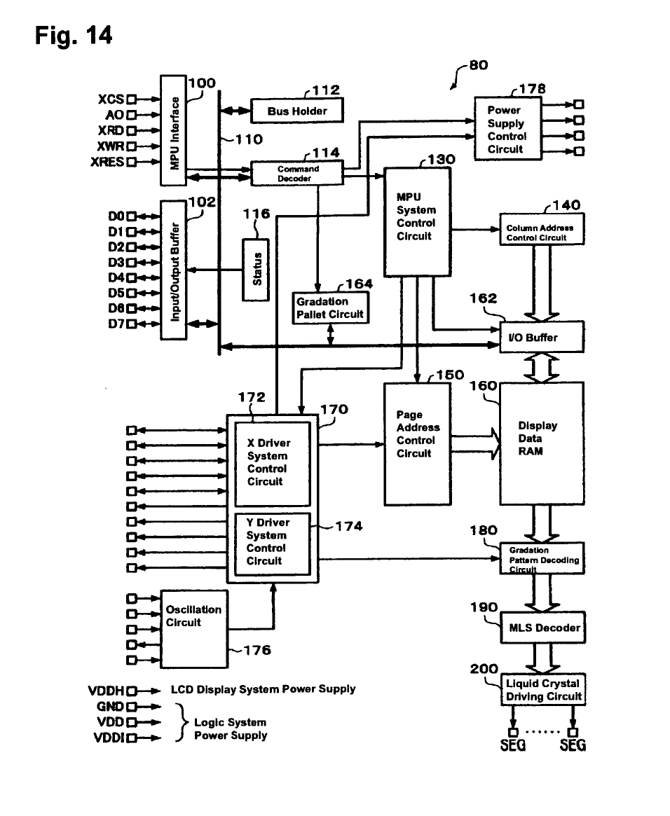

FIG. 14 shows an example of the signal driver 14. The signal driver 14 is applied as a RAM built-in X driver IC 80.

As an input/output circuit for the RAM built-in X driver IC 80, a Micro Processing Unit (MPU) interface 100 and an input/output buffer 102 are provided.

An inverted chip select signal XCS, a signal to identify command or data A0, an inverse read signal XRD, an inverse write signal XWR, and an inverse reset signal XRES are input in the MPU interface 100. For example, 8-bit commands or display data D7-D9 are input in the input/output buffer 102.

The RAM built-in X driver IC 80 is provided with a bus line 110 that is connected to the MPU interface 10 and the input/output buffer 102.

The bus line 110 is connected to a bus holder 112 and a command decoder 114. The input/output buffer 102 is connected to a status setting circuit 116, which outputs operation status of the RAM built-in X driver IC 80 to the MPU. The operation status refers to an internal status that is set by the RAM built-in X driver IC 80, which may indicate, for example, whether or not the display is in an ON state, a scroll mode of a given scroll region within the screen, and the like. The operation status is output as a result of decoding, by the command decoder 114, a given command input from the MPU. The bus line 110 is connected to an I/O buffer 162 of a display data RAM 160, and transmits display data to be read from or write in the display data RAM 160.

Also, the RAM built-in X driver IC 80 includes a gradation pallet circuit 164. The gradation pallet circuit 26 indicated in FIG. 2 and FIGS. 7-10 may be adopted as the gradation pallet circuit 164. Gradation data, such as, display data having 8 gradations, 16 gradations or 32 gradations are input through the input/output buffer 102 in the gradation pallet circuit 164, which converts the same into display data having 32 gradations or outputs that are the same without converting. For this reason, display data that are to be correlated to the display data input through the input/output buffer 102 can be set in advance, using the MPU, for example, by the command decoder 114. The gradation pallet circuit 164 may perform the above conversion of the display data transmitted on the bus line 110, and may supply the same to the I/O buffer 162. Alternatively, the gradation pallet circuit 164 may be structured to be included in the input/output buffer 102.

The RAM built-in X driver IC 80 can be provided with, in addition to the aforementioned display data RAM 160 and the I/O buffer 162, an MPU system control circuit 130, a column address control circuit 140, a page address control circuit 150, a driver system control circuit 170, a gradation pattern decoding circuit 180, an MLS decoder 190, and a liquid crystal driver circuit 200.

The gradation pattern decoding circuit 20 indicated in FIG. 2, FIG. 7, FIGS. 11 (A)-(D), FIG. 12, and FIG. 13 can be adopted as the gradation pattern decoding circuit 180. The MLS decoder 58 indicated in FIG. 7, for example, can be implemented as the MLS decoder 190.

The MPU system control circuit 130 controls reading and writing operations for the display data RAM 160 based on commands from the MPU input through the command decoder 114. The MPU system control circuit 130 controls the column address control circuit 140 and the page address control circuit 150. The column address control circuit 140 designates write column addresses and read column addresses of display data. The page address control circuit 150 designates write page addresses of display data and read page addresses of display data.

Also, the page address control circuit 150 is controlled by the driver system control circuit 170 to designate display addresses for each line. The driver system control circuit 170 includes an X driver system control circuit 172 and a Y driver system control circuit 174. The driver system control circuit 170 generates gradation control pulses GCP, polarity inversion pulses FR, and latch pulses LP based on oscillation outputs from an oscillation circuit 176, and controls the page address control circuit 150, the gradation pattern decoding circuit 180, a power supply control circuit 178 and an Y driver IC. The scanning driver 16 indicated in FIG. 1, for example, can be adopted as the Y driver IC.

The X driver system control circuit 172 includes a divider circuit that functions as the frame frequency conversion circuit 24 indicated in FIG. 2. The X driver system control circuit 172 performs frame controlling for the gradation pattern decoding circuit 180 with frame frequencies set at first and second frequencies that are provided by dividing the oscillation output according to dividing ratios designated by the MPU system control circuit 130.

The gradation pattern decoding circuit 180 latches data that are read out by the display data RAM 160. The gradation pattern decoding circuit 180 outputs gradation patterns based on gradations corresponding to the gradation data, which are converted to MLS operation results by the MLS decoder 190, as described above. The liquid crystal driver circuit 200 shifts signals from the MLS decoder 190 to voltages corresponding to the voltages of the LCD display system, which are supplied to the segment electrodes SEG of the liquid crystal panel 12 indicated in FIG. 1.

1.3 Electronic Apparatuses

Next, descriptions will be made as to the case in which an electrooptic apparatus, such as, a liquid crystal display apparatus using a display driver circuit, such as, the signal driver (described above) is applied to an electronic apparatus, such as, a portable telephone 250.

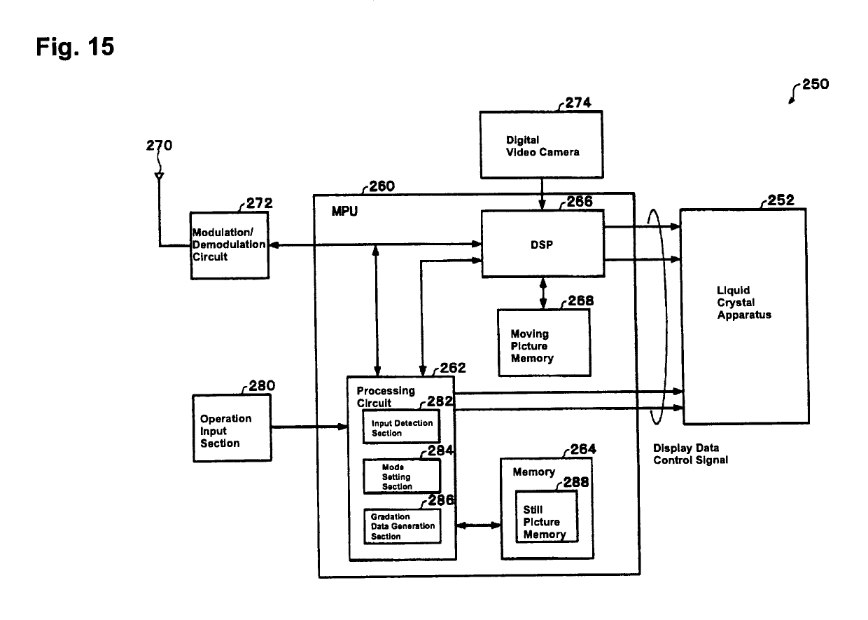

FIG. 15 shows an example in which a liquid crystal apparatus that uses the signal driver, as described above, in a portable telephone.

The portable telephone 250 includes a liquid crystal apparatus 252 and an MPU 260. The liquid crystal apparatus 10 indicated in FIG. 1 may be adopted as the liquid crystal apparatus 252.

The MPU 260 includes a processing circuit 262 that governs the control of the portable telephone 250. The processing circuit 262 is connected to a memory 264 and a Digital Signal Processor (DSP) 266. Also, the DSP 266 is connected to a moving picture memory 268.

The portable telephone 250 is provided with a modulation/demodulation circuit 272 that demodulates signals received through an antenna 270, and modulates signals that are to be transmitted through the antenna 270. Further, the portable telephone 250 is capable of transmitting and receiving through the antenna 270 moving picture data that are encoded according the MPEG (Moving Picture Experts Group) Layer IV standard.

The portable telephone 250 can also be provided with, for example, a digital video camera 274, and can take in moving picture data through the digital video camera 274. Operation information required for data transmission and data reception by the portable telephone 250, and for photographing by the digital video camera 274 is input through an operation input section 280.

The processing circuit 262 includes an input detection section 282, a mode setting section 284 and a gradation generation section 286, and can realize functions of the respective sections, for example, by the CPU and software that operates the CPU.

The input detection section 282 monitors presence or absence of inputs of operation information from the operation input section 280. The input detection section then notifies the mode setting section 284 of the results of detecting presence or absence of inputs of operation information. The mode setting section 284 sets the liquid crystal apparatus 252 in the aforementioned first mode or second mode based on the detection results of the input detection section 282.

The gradation data generation section 286 generates gradation data, based on operation information from the operation input section 280, from display data that is input, for example, through the antenna 270 or the digital video camera 274.

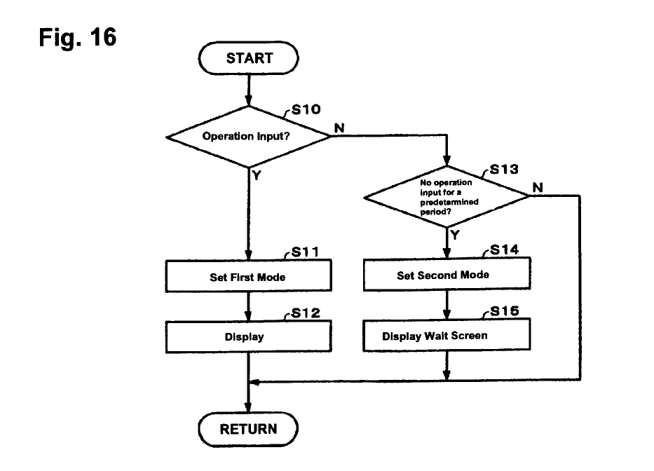

FIG. 16 shows an example of a flowchart of the operation of the processing circuit 262.

First, the input detection section 282 detects presence or absence of operation information input through the operation input section 280 (step S10).

When the input detection section 282 detects that operation information is input through the operation input section 280 by the user (step S10: Y), the mode setting section 284 sets the aforementioned first mode (step S11). More specifically, the mode setting section 284 of the processing circuit 262 issues a command to the signal driver of the liquid crystal apparatus 252, to switch the given switching control signal. As a result, the number of colors of the gradations is changed to the first number of colors (for example, 4096 colors), and the frame frequency is changed to the first frame frequency f1. As a result, by the input of operation information, the back light of the display section of the portable telephone may be lit so that images on the liquid crystal display become more visible. Since the frame frequency increases in a state in which the number of gradations is increased, images with a higher image quality can be displayed (step S12).

On the other hand, if in step S10 the input detection section 282 does not detect any input of operation information through the operation input section 280 by the user (step S10: N), then a determination is made if a predetermined time has elapsed in a state without inputs of operation information (step S13).

When it is determined that the predetermined time has not elapsed in the state without inputs of operation information (step S13: N), presence or absence of inputs of operation information is detected again (RETURN).

On the other hand, when it is determined that the predetermined time has elapsed in a state without inputs of operation information (step S13: Y), the mode setting section 284 sets the aforementioned second mode (step S14). More specifically, the mode setting section 284 of the processing circuit 262 issues a command to the signal driver of the liquid crystal apparatus 252, to switch the given switching control signal. By this, in the signal driver the number of colors of the gradations is changed to the second number of colors (for example, 256 colors) that is less than the first number of colors. In addition, the frame frequency is changed to the second frame frequency f2 that is lower than the first frequency. As a result, by the absence of inputs of operation information, the back light of the display section of the portable telephone may be turned off. In addition, the number of colors of gradations is dropped, such that images with a lower image quality are displayed at a lower frame frequency (step S15).

When moving pictures are displayed in a moving picture display region of the liquid crystal panel 12, the processing circuit 262 provided in the MPU 260 can decide the size of the moving pictures based on moving picture information. Moving pictures to be displayed in the moving picture display region are supplied through the antenna 270 or the digital video camera 274. Signals input through the antenna 270 are demodulated by the modulation/demodulation circuit 272, and subject to signal processing by the DSP 266. The DSP 266 is connected to a moving picture (processing) memory 268. The DSP266 decompresses compressed data that is input through the antenna 270 and the modulation/demodulation circuit 272, or decodes data that is encoded by the MPEG Layer IV standard. Data to be transmitted through the modulation/demodulation circuit 272 and the antenna 270 is compressed by the DSP 266, or encoded when encoded data according to the MPEG Layer IV standard is transmitted. In this manner, the DSP 266 can function as a decoder and encoder according to, for example, the MPEG Layer IV standard.

Signals from the digital video camera 274 are also input into the DSP 266. Signals input through the antenna 270 or the digital video camera 274 are processed into RGB signals by the DSP 266, and supplied as display data to the liquid crystal apparatus 252.

Based on operation information or the like from the operation input section 280, the processing circuit 262 uses a still picture memory 288 to output commands and still image data. These may be necessary for displaying still pictures to be displayed on the liquid crystal apparatus of the liquid crystal apparatus 252 depending on requirements.

For example, moving pictures may be movie information that is distributed via the Internet. Information for ordering theater tickets may be displayed as still pictures, and a purchase order for tickets may be placed based on information input through the operation section 280. The processing circuit 262 further performs transmission controls through the modulation/demodulation circuit 272 and the antenna 270 over still picture information, such as, purchase order information. Also, the processing circuit 262 may perform transmission controls over information of moving pictures that are photographed by the digital video camera 274, depending on requirements, through the modulation/demodulation circuit 272 and the antenna 270.

Other Embodiments

In the embodiments described above, a display driving circuit such as a signal driver that performs gradation displays by FRC is described. However, without being limited to this embodiment, a signal driver that performs gradation displays by PWM, which lowers power consumption and maintains the display quality, can also be implemented.

2.1 Display driving circuit (Signal Driver)

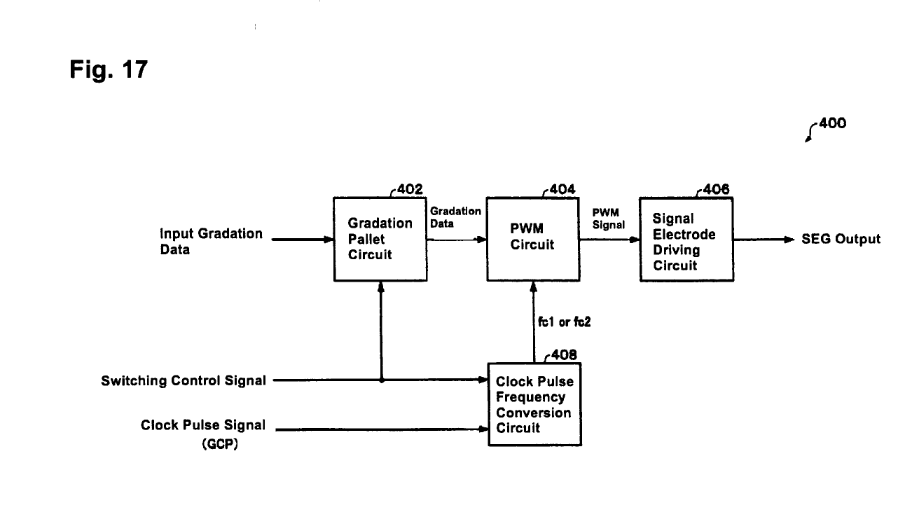

FIG. 17 shows a signal driver in accordance with other embodiments of the present invention. The signal driver 400 includes a gradation pallet circuit 402, a PWM circuit 404, a signal electrode driving circuit 406, and a clock pulse frequency conversion circuit 408.

The gradation pallet circuit 402 sets the number of colors of gradations to a first number or second number of colors based on a given switching control signal. For example, the gradation pallet circuit 26 indicated in FIG. 2 may be adopted as this kind of gradation pallet circuit 402.

The PWM circuit 404, based on a clock pulse signal that is a clock that determines the pulse width, generates a PWM signal having a pulse width corresponding to gradation data that is output from the gradation pallet circuit 402. For example, when a constant number of clock pulses appear in the signal in each horizontal scanning period, a pulse width modulation can be performed by generating a PWM signal whose changing points coincide with positions at which clock pulses in the clock pulse signal, in the number corresponding to the gradation data, appear.

The signal electrode driving circuit 406 drives the signal electrodes based on the PWM signal generated by the PWM circuit 404.

The clock pulse frequency conversion circuit 408 sets the frequency of the aforementioned clock pulse signal to a first clock pulse frequency fc1 or a second clock pulse frequency fc2 based on given switching control signals. This type of clock pulse frequency conversion circuit 408 can be realized by, for example, a divider circuit. Using this divider circuit, a circuit that converts to the first or second clock pulse frequency by changing the dividing ratio can be implemented.

The signal driver 400 thus structured can change the frequency of the clock pulse signal for generating pulse widths by given switching control signals according to a number of colors of gradations that is changeable.

Here, for example, the switching control signal is controlled by an external CPU that may switch to the first number of colors in a first mode, and to the second number of colors in a second mode.

In the PWM method, the frame frequency is fixed unlike the FRC method. A predetermined number of pulses in the clock pulse signal that corresponds to the number of gradations are required in each horizontal scanning period. Therefore, when the display quality is to be improved by increasing the number of colors of gradations, it is necessary to increase the frequency of the clock pulse signal. This can result in an increased power consumption.

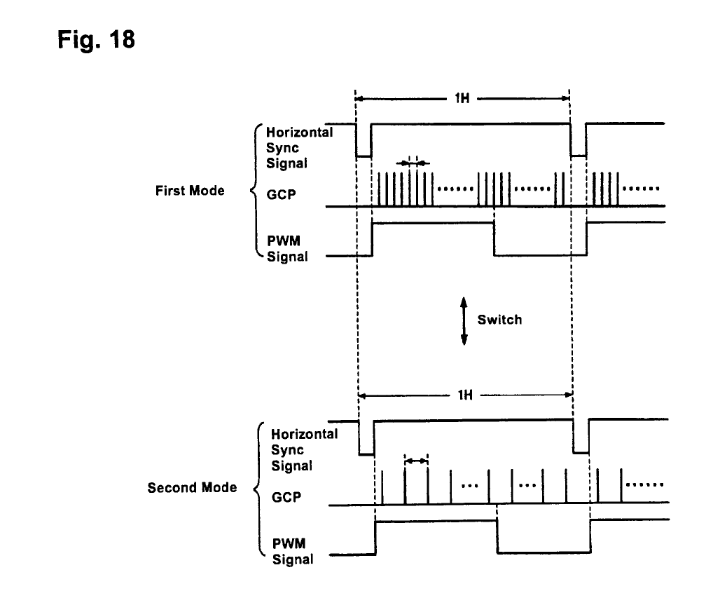

The signal driver 400 discriminates the case where a high image quality display is performed from the case where a lower image quality display is performed, changes the number of colors of gradations, and changes the frequency of the clock pulse signal (GCP) for creating pulse widths as indicated in FIG. 18.

For example, the first mode may be a display mode with a high image quality in which the PWM is performed based on gradation data having a first number of colors with the frequency of the clock pulse signal being at a first clock pulse frequency fc1. The second mode may be a display mode with a lower image quality in which the PWM is performed based on gradation data having a second number of colors that is fewer than the first number of colors with the frequency of the clock pulse signal being at a second clock pulse frequency fc2 that is lower than the first clock pulse frequency.

With this structure, and by appropriately switching between the first mode and the second mode, cases in which pictures with a high image quality, that are excellent in the reproducibility, are to be displayed are discriminated from cases in which such is not required. The number of colors of gradations can also be appropriately changed, such that the power consumption can be reduced with appropriate clock pulse frequencies for generating pulse widths.

The signal driver 400 described above can be applied to a liquid crystal apparatus such as that indicated in FIG. 1.

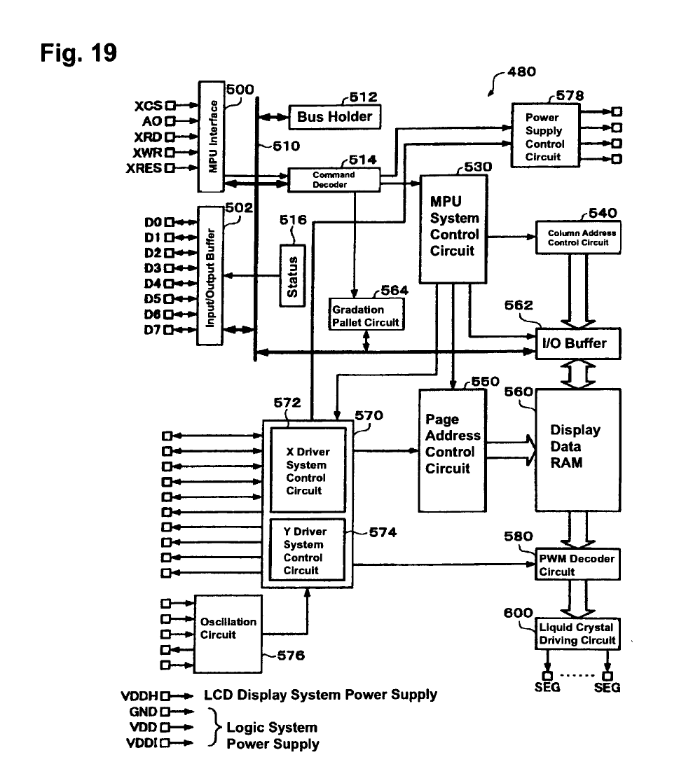

FIG. 19 shows a block diagram of one example of the signal driver 400. The signal driver 400 is applied as a RAM built-in X driver IC 480.

As an input/output circuit for the RAM built-in X driver IC 480, an MPU interface 500 and an input/output buffer 502 are provided.

An inverted chip select signal XCS, a signal to identify command or data A0, an inverse read signal XRD, an inverse write signal XWR, and an inverse reset signal XRES are input in the MPU interface 500.

For example, 8-bit commands or display data D7-D9 are input in the input/output buffer 502.

The RAM built-in X driver IC 480 is provided with a bus line 510 that is connected to the MPU interface 500 and the input/output buffer 502.

The bus line 510 is connected to a bus holder 512 and a command decoder 514. The input/output buffer 502 is connected to a status setting circuit 516, which outputs operation status of the RAM built-in X driver IC 480 to the MPU. The operation status refers to an internal status that is set by the RAM built-in X driver IC 480, which may indicate, for example, whether or not the display is in an ON state, a scroll mode of a given scroll region within the screen, and the like. The operation status is output as a result of decoding, by the command decoder 514, a given command input from the MPU.

The bus line 510 is connected to an I/O buffer 562 of a display data RAM 560, and transmits display data to be read from or written into the display data RAM 560.

Also, the RAM build-in X driver IC 480 includes a gradation pallet circuit 564. For example, the gradation pallet circuit 402 indicated in FIG. 17 may be implemented as the gradation pallet circuit 564. Display data such as gradation data having 8 gradations, 16 gradations or 32 gradations can be input through the input/output buffer 502 in the gradation pallet circuit 564, which converts the same into display data having 32 gradations. For this reason, display data that are to be correlated to the display data input through the input/output buffer 502 can be set in advance, using the MPU, for example, by the command decoder 514. The gradation pallet circuit 564 may perform the above conversion of the display data transmitted on the bus line 510, and may supply the same to the I/O buffer 562. Alternatively, the gradation pallet circuit 564 may be included in the input/output buffer 502.

The RAM built-in X driver IC 480 is provided with, in addition to the aforementioned display data RAM 560 and the I/O buffer 562, an MPU system control circuit 530, a column address control circuit 540, a page address control circuit 550, a driver system control circuit 570, a PWM decoder circuit 580, and a liquid crystal driver circuit 600. The PWM circuit indicated in FIG. 17 may be adopted as the PWM decoder circuit 580.

The MPU system control circuit 530 controls reading and writing operations for the display data RAM 560 based on commands from the MPU input through the command decoder 514. The MPU system control circuit 530 controls the column address control circuit 540 and the page address control circuit 550. The column address control circuit 540 designates write column addresses and read column addresses of display data. The page address control circuit 550 designates write page addresses of display data and read page addresses of display data.

The page address control circuit 550 is controlled by the driver system control circuit 570 to designate display addresses for each line. The driver system control circuit 570 includes an X driver system control circuit 572 and a Y driver system control circuit 574. The driver system control circuit 570 generates gradation control pulses GCP as clock pulse signals for creating pulse widths, polarity inversion pulses FR, and latch pulses LP based on oscillation outputs from an oscillation circuit 576. The driver system control circuit 570 controls the page address control circuit 550, the PMW decoder circuit 580, a power supply control circuit 578 and an Y driver IC. Here, for example, the scanning driver 16 indicated in FIG. 1 can be adopted as the Y driver IC.

The X driver system control circuit 572 includes a divider circuit that has a function of the clock pulse frequency conversion circuit 408 indicated in FIG. 17. The X driver system control circuit 572 is capable of supplying to the PWM decoder circuit 580 gradation control pulses GCP in a first or second clock pulse frequency that is obtained by dividing the oscillation output according to a dividing ratio designated by the MPU system control circuit 530.

The liquid crystal driver circuit 600 shifts signals provided from the PWM decoder circuit 580 to voltages according to the voltages of the LCD display system which are supplied to the segment electrodes SEG of the liquid crystal panel 12 indicated in FIG. 1.

A liquid crystal apparatus in which the signal driver 400 is implemented can be utilized in an electronic apparatus such as the portable telephone indicated in FIG. 15.

Electronic apparatuses in which the electrooptic apparatus described above is implemented may preferably include apparatuses in which there are strong demand towards lower power consumption, such as, for example, pagers, watches, and PDAs, in addition to the portable telephones described above. In addition, the above may preferably be applied to liquid crystal TVs, video tape recorders in a viewfinder type or a monitor direct viewing type, car navigation apparatuses, desk-top calculators, word processors, work stations, TV telephones, POS consoles, and apparatuses equipped with touch-panels.

While aspects of the present invention have been described in terms of certain preferred embodiments, those of ordinary skill in the will appreciate that certain variations, extensions and modifications may be made without varying from the basic teachings of the present invention. For example, although the description above refers to a “liquid crystal” apparatus, those of skill in the art will appreciate that other types of “electrooptic” apparatuses or “display” apparatuses could be utilized. Similarly, although the description above refers to a “liquid crystal” panel, other types of “display” panels could be utilized to implement the techniques described above. While the signal driver in the above embodiments is described as having a built-in display data RAM, the present invention is not limited to such construction. As such, aspects of the present invention are not to be limited to the specific preferred embodiments described herein. Rather, the scope of the present invention is to be determined from the claims, which follow.

What is claimed is:

1. A display driving circuit that drives signal electrodes of a display panel having a plurality of scanning electrodes and a plurality of signal electrodes mutually crisscrossing one another for displaying gradations by a frame rate control method, the display driving circuit comprising:
a frame frequency conversion circuit that switches a frame frequency to a first or second frequency based on a given switching control signal;
a gradation pattern decoding circuit that successively performs decoding for each frame and outputs a gradation pattern for designating frames that are to be displayed on or displayed off by a frame rate control method according to gradation data based on a frame frequency of the first or second frequency; and
a signal electrode driving circuit that drives the signal electrodes based on the gradation patterns,
wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal; and
the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode.

2. A display driving circuit according to claim 1, further comprising:
a first gradation pallet circuit that converts given input gradation data to the gradation data of the first number of colors in the first mode, and a second gradation pallet circuit that converts the given input gradation data to the gradation data of the second number of colors in the second mode, wherein the gradation pattern decoding circuit performs decoding and outputs a gradation pattern based on gradation data that is converted by the first or second gradation pallet circuit.

3. A display driving circuit that drives signal electrodes of a display panel having a plurality of scanning electrodes and a plurality of signal electrodes mutually crisscrossing one another for displaying gradations by a pulse width modulation method, the display driving circuit comprising:
a gradation pallet circuit that converts given input gradation data to gradation data having a first number of colors or gradation data having a second number of colors that is fewer than the first number of colors;
a clock pulse frequency conversion circuit that switches a frequency of a clock pulse signal for performing a pulse width modulation to a first or second clock pulse frequency based on a given switching control signal;
a pulse width modulation circuit that generates a pulse width modulation signal having a pulse width corresponding to gradation data output from the gradation pallet circuit, based on the clock pulse signal having a frequency that is converted to the first or second clock pulse frequency; and
a signal electrode driving circuit that drives the signal electrodes using the pulse width modulation signal,
wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal; and
the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode.

4. An electrooptic apparatus, comprising:
pixels that are specified by a plurality of scanning electrodes and a plurality of signal electrodes mutually crisscrossing one another;
a display driving circuit that drives signal electrodes of a display panel having a plurality of scanning electrodes and a plurality of signal electrodes mutually crisscrossing one another for displaying gradations by a frame rate control method, the display driving circuit comprising:
a frame frequency conversion circuit that switches a frame frequency to: a first or second frequency based on a given switching control signal;
a gradation pattern decoding circuit that successively performs decoding for each frame and outputs a gradation pattern for designating frames that are to be displayed on or displayed off by a frame rate control method according to gradation data based on a frame frequency of the first or second frequency; and
a signal electrode driving circuit that drives the signal electrodes based on the gradation patterns,
wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal; and
the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode; and
a scanning driver that drives the scanning electrodes.

5. An electrooptic apparatus according to claim 4, wherein the display driving circuit further comprises:
a first gradation pallet circuit that converts given input gradation data to the gradation data of the first number of colors in the first mode, and a second gradation pallet circuit that converts the given input gradation data to the gradation data of the second number of colors in the second mode, wherein the gradation pattern decoding circuit performs decoding and outputs a gradation pattern based on gradation data that is converted by the first or second gradation pallet circuit.

6. An electrooptic apparatus, comprising:
pixels that are specified by a plurality of scanning electrodes and a plurality of signal electrodes mutually crisscrossing one another;
a display driving circuit display driving circuit that drives signal electrodes of a display panel having a plurality of scanning electrodes and a plurality of signal electrodes mutually crisscrossing one another for displaying gradations by a pulse width modulation method, the display driving circuit comprising:
a gradation pallet circuit that converts given input gradation data to gradation data having a first number of colors or gradation data having a second number of colors that is fewer than the first number of colors;
a clock pulse frequency conversion circuit that switches a frequency of a clock pulse signal for performing a pulse width modulation to a first or second clock pulse frequency based on a given switching control signal;
a pulse width modulation circuit that generates a pulse width modulation signal having a pulse width corresponding to gradation data output from the gradation pallet circuit, based on the clock pulse signal having a frequency that is converted to the first or second clock pulse frequency; and
a signal electrode driving circuit that drives the signal electrodes using the pulse width modulation signal,
wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal; and
wherein the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode; and
a scanning driver that drives the scanning electrodes.

7. An electrooptic apparatus, comprising:
a display panel including pixels that are specified by a plurality of scanning electrodes and a plurality of signal electrodes mutually crisscrossing one another;
a display driving circuit that drives signal electrodes of a display panel having a plurality of scanning electrodes and a plurality of signal electrodes mutually crisscrossing one another for displaying gradations by a frame rate control method, the display driving circuit comprising:
a frame frequency conversion circuit that switches a frame frequency to a first or second frequency based on a given switching control signal;
a gradation pattern decoding circuit that successively performs decoding for each frame and outputs a gradation pattern for designating frames that are to be displayed on or displayed off by a frame rate control method according to gradation data based on a frame frequency of the first or second frequency; and
a signal electrode driving circuit that drives the signal electrodes based on the gradation patterns,
wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal; and
the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode; and
a scanning driver that drives the scanning electrodes.

8. An electrooptic apparatus according to claim 7, wherein the display driving circuit further comprises:
a first gradation pallet circuit that converts given input gradation data to the gradation data of the first number of colors in the first mode, and a second gradation pallet circuit that converts the given input gradation data to the gradation data of the second number of colors in the second mode, wherein the gradation pattern decoding circuit performs decoding and outputs a gradation pattern based on gradation data that is converted by the first or second gradation pallet circuit.

9. An electrooptic apparatus comprising:
a display panel including pixels that are specified by a plurality of scanning electrodes and a plurality of signal electrodes mutually crisscrossing one another;
a display driving circuit that drives signal electrodes of a display panel having a plurality of scanning electrodes and a plurality of signal electrodes mutually crisscrossing one another for displaying gradations by a pulse width modulation method, the display driving circuit comprising:
a gradation pallet circuit that converts given input gradation data to gradation data having a first number of colors or gradation data having a second number of colors that is fewer than the first number of colors;
a clock pulse frequency conversion circuit that switches a frequency of a clock pulse signal for performing a pulse width modulation to a first or second clock pulse frequency based on a given switching control signal;
a pulse width modulation circuit that generates a pulse width modulation signal having a pulse width corresponding to gradation data output from the gradation pallet circuit, based on the clock pulse signal having a frequency that is converted to the first or second clock pulse frequency; and
a signal electrode driving circuit that drives the signal electrodes using the pulse width modulation signal,
wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal; and
the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode; and
a scanning driver that drives the scanning electrodes.

10. An electronic apparatus comprising:
an operation input section for inputting operation information;
an input presence/absence detection section that detects whether operation information is input from the operation input section;
a gradation data generation section that generates input gradation data based on the operation information that is input from the operation input section;
an electrooptic apparatus comprising:
pixels that are specified by a-plurality of scanning electrodes and a plurality of signal electrodes mutually crisscrossing one another,
a display driving circuit that drives signal electrodes of a display panel having a plurality of scanning electrodes and a plurality of signal electrodes mutually crisscrossing one another for displaying gradations by a frame rate control method, the display driving circuit comprising
a frame frequency conversion circuit that switches a frame frequency to a first or second frequency based on a given switching control signal,
a gradation pattern decoding circuit that successively performs decoding for each frame and outputs a gradation pattern for designating frames that are to be displayed on or displayed off by a frame rate control method according to gradation data based on a frame frequency of the first or second frequency, and
a signal electrode driving circuit that drives the signal electrodes based on the gradation patterns,
wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal, and
wherein the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode, and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

11. An electronic apparatus according to claim 10, wherein the display driving circuit further comprises:
a first gradation pallet circuit that converts given input gradation data to the gradation data of the first number of colors in the first mode, and a second gradation pallet circuit that converts the given input gradation data to the gradation data of the second number of colors in the second mode, wherein the gradation pattern decoding circuit performs decoding and outputs a gradation pattern based on gradation data that is converted by the first or second gradation pallet circuit.

12. An electronic apparatus, comprising:
an operation input section for inputting operation information;
an input presence/absence detection section that detects whether operation information is input from the operation input section;
a gradation data generation section that generates input gradation data based on the operation information that is input from the operation input section;
an electrooptic apparatus comprising
pixels that are specified by a plurality of scanning electrodes and a plurality of signal electrodes mutually crisscrossing one another,
a display driving circuit display driving circuit that drives signal electrodes of a display panel having a plurality of scanning electrodes and a plurality of signal electrodes mutually crisscrossing one another for displaying gradations by a pulse width modulation method, the display driving circuit comprising
a gradation pallet circuit that converts given input gradation data to gradation data having a first number of colors or gradation data having a second number of colors that is fewer than the first number of colors,
a clock pulse frequency conversion circuit that switches a frequency of a clock pulse signal for performing a pulse width modulation to a first or second clock pulse frequency based on a given switching control signal,
a pulse width modulation circuit that generates a pulse width modulation signal having a pulse width corresponding to gradation data output from the gradation pallet circuit, based on the clock pulse signal having a frequency that is converted to the first or second clock pulse frequency, and
a signal electrode driving circuit that drives the signal electrodes using the pulse width modulation signal,
wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal, and
wherein the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode; and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

13. An electronic apparatus, comprising:
an operation input section for inputting operation information;
an input presence/absence detection section that detects whether operation information is input from the operation input section;
a gradation data generation section that generates input gradation data based on the operation information that is input from the operation input section;
electrooptic apparatus comprising
a display panel including pixels that are specified by a plurality of scanning electrodes and a plurality of signal electrodes mutually crisscrossing one another,
a display driving circuit that drives signal electrodes of a display panel having a plurality of scanning electrodes and a plurality of signal electrodes mutually crisscrossing one another for displaying gradations by a frame rate control method, the display driving circuit comprising
a frame frequency conversion circuit that switches a frame frequency to a first or second frequency based on a given switching control signal,
a gradation pattern decoding circuit that successively performs decoding for each frame and outputs a gradation pattern for designating frames that are to be displayed on or displayed off by a frame rate control method according to gradation data based on a frame frequency of the first or second frequency, and
a signal electrode driving circuit that drives the signal electrodes based on the gradation patterns,
wherein the gradation pattern decoding circuit performs decoding and outputs a gradation pattern according to gradation data having a first number of colors in a first mode that is set based on the switching control signal, and performs decoding and outputs a gradation pattern according to gradation data having a second number of colors that is fewer than the first number of colors in a second mode that is set based on the switching control signal, and
the frame frequency conversion circuit switches the frame frequency from a first frequency to a second frequency that is lower than the first frequency when the first mode is switched to the second mode, and switches the frame frequency from the second frequency to the first frequency when the second mode is switched to the first mode; and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

14. An electronic apparatus according to claim 13, wherein the display driving circuit further comprises:
a first gradation pallet circuit that converts given input gradation data to the gradation data of the first number of colors in the first mode, and a second gradation pallet circuit that converts the given input gradation data to the gradation data of the second number of colors in the second mode, wherein the gradation pattern decoding circuit performs decoding and outputs a gradation pattern based on gradation data that is converted by the first or second gradation pallet circuit.

15. An electronic apparatus, comprising:
an operation input section for inputting operation information;
an input presence/absence detection section that detects whether operation information is input from the operation input section;
a gradation data generation section that generates input gradation data based on the operation information that is input from the operation input section;
a display panel including pixels that are specified by a plurality of scanning electrodes and a plurality of signal electrodes mutually crisscrossing one another;
a display driving circuit that drives signal electrodes of a display panel having a plurality of scanning electrodes and a plurality of signal electrodes mutually crisscrossing one another for displaying gradations by a pulse width modulation method, the display driving circuit comprising
a gradation pallet circuit that converts given input gradation data to gradation data having a first number of colors or gradation data having a second number of colors that is fewer than the first number of colors,
a clock pulse frequency conversion circuit that switches a frequency of a clock pulse signal for performing a pulse width modulation to a first or second clock pulse frequency based on a given switching control signal,
a pulse width modulation circuit that generates a pulse width modulation signal having a pulse width corresponding to gradation data output from the gradation pallet circuit, based on the clock pulse signal having a frequency that is converted to the first or second clock pulse frequency; and
a signal electrode driving circuit that drives the signal electrodes using the pulse width modulation signal,
wherein the gradation pallet circuit converts the input gradation data to gradation data having a first number of colors in a first mode that is set based on the switching control signal, and converts the input gradation data to gradation data having a second number of colors that is fewer than the first number of colors in a second mode that is set based on the switching control signal; and
the clock pulse frequency conversion circuit switches the frequency of the clock pulse signal from a first clock pulse frequency to a second clock pulse frequency that is lower than the first clock pulse frequency when the first mode is switched to the second mode, and switches the frequency of the clock pulse signal from the second clock pulse frequency to the first clock pulse frequency when the second mode is switched to the first mode; and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

16. A display driving method that drives signal electrodes of a display panel having a plurality of scanning electrodes and a plurality of signal electrodes mutually crisscrossing one another for displaying gradations by a frame rate control method , the display driving method comprising:
performing decoding and outputting a gradation pattern for designating frames that are to be displayed on or displayed off by a frame rate control method according to gradation data having a first number of colors in a first mode that is set based on a given switching control signal, and performing decoding and outputting a gradation pattern according to gradation data having a second number of colors that is fewer than the first number of colors in a second mode that is set based on the switching control signal;
switching the frame frequency from a first frequency to a second frequency that is lower than the first frequency when the first mode is switched to the second mode, and switching the frame frequency from the second frequency to the first frequency when the second mode is switched to the first mode; and
driving the signal electrodes at the first or second frequency, based on the gradation pattern decoded and output with the frame frequency having the first or second frequency.

17. A display driving method for displaying gradations by a frame rate control method for a display panel having a plurality of scanning electrodes and a plurality of signal electrodes mutually crisscrossing one another, the display driving method comprising:
changing a frame frequency for displaying gradations by a frame rate control method according to a changeable number of colors of gradations; and
displaying gradations using the changed frame frequency.

18. A display driving method according to claim 17, wherein, when the number of colors is a first number of colors, the frame frequency is set to a first frequency, and when the number of colors is a second number of colors that is fewer than the first number of colors, the frame frequency is set to a second frequency that is lower than the first frequency.

19. A display driving method that drives signal electrodes of a display panel having a plurality of scanning electrodes and a plurality of signal electrodes mutually crisscrossing one another for displaying gradations by a pulse width modulation method, the display driving method comprising:
converting given input gradation data to gradation data having a first number of colors in a first mode that is set based on a given switching control signal, and converting the input gradation data to gradation data having a second number of colors that is fewer than the first number of colors in a second mode that is set based on the switching control signal;
switching the frequency of the clock pulse signal from a first clock pulse frequency to a second clock pulse frequency that is lower than the first clock pulse frequency when the first mode is switched to the second mode, and switching the frequency of the clock pulse signal from the second clock pulse frequency to the first clock pulse frequency when the second mode is switched to the first mode;
generating a pulse width modulation signal having a pulse width corresponding to gradation data having the first or second number of colors, based on the clock pulse signal having a frequency that is converted to the first or second clock pulse frequency; and
driving the signal electrodes using the pulse width modulation signal.

20. A display driving method for displaying gradations by a pulse width modulation method for a display panel having a plurality of scanning electrodes and a plurality of signal electrodes mutually crisscrossing one another, the display driving method comprising:
changing a frequency of a clock pulse signal for generating a pulse width modulation signal according to a changeable number of color for gradations; and
displaying gradations using the changed frequency of the clock pulse signal.

21. A display driving method according to claim 20, wherein, when the number of colors is a first number of colors, the clock pulse frequency of the clock pulse signal is set at a first clock pulse frequency, and when the number of colors is a second number of colors that is fewer than the first number of colors, the clock pulse frequency of the clock pulse signal is set at a second clock pulse frequency that is lower than the first clock pulse frequency.

22. A display driver that drives signal electrodes of a display panel having a plurality of scanning electrodes and a plurality of signal electrodes mutually crisscrossing one another for displaying gradations by a frame rate control method, the display driver comprising:
means for decoding and outputting a gradation pattern for designating frames that are to be displayed on or displayed off by a frame rate control method according to gradation data having a first number of colors in a first mode that is set based on a given switching control signal, and performing decoding and outputting a gradation pattern according to gradation data having a second number of colors that is fewer than the first number of colors in a second mode that is set based on the switching control signal;
means for switching the frame frequency from a first frequency to a second frequency that is lower than the first frequency when the first mode is switched to the second mode, and switching the frame frequency from the second frequency to the first frequency when the second mode is switched to the first mode; and
means for driving the signal electrodes at the first or second frequency, based on the gradation pattern decoded and output with the frame frequency having the first or second frequency.

23. A display driver for displaying gradations by a frame rate control method for a display panel having a plurality of scanning electrodes and a plurality of signal electrodes mutually crisscrossing one another, the display driver comprising:
means for changing a frame frequency for displaying gradations by a frame rate control method according to a changeable number of colors of gradations; and
means for displaying gradations using the changed frame frequency.

24. A display driver according to claim 23, wherein, when the number of colors is a first number of colors, the frame frequency is set to a first frequency, and when the number of colors is a second number of colors that is fewer than the first number of colors, the frame frequency is set to a second frequency that is lower than the first frequency.

25. A display driver that drives signal electrodes of a display panel having a plurality of scanning electrodes and a plurality of signal electrodes mutually crisscrossing one another for displaying gradations by a pulse width modulation method, the display driver comprising:
means for converting given input gradation data to gradation data having a first number of colors in a first mode that is set based on a given switching control signal, and converting the input gradation data to gradation data having a second number of colors that is fewer than the first number of colors in a second mode that is set based on the switching control signal;
means for switching the frequency of the clock pulse signal from a first clock pulse frequency to a second clock pulse frequency that is lower than the first clock pulse frequency when the first mode is switched to the second mode, and switching the frequency of the clock pulse signal from the second clock pulse frequency to the first clock pulse frequency when the second mode is switched to the first mode;
means for generating a pulse width modulation signal having a pulse width corresponding to gradation data having the first or second number of colors, based on the clock pulse signal having a frequency that is converted to the first or second clock pulse frequency; and
means for driving the signal electrodes using the pulse width modulation signal.

26. A display driver for displaying gradations by a pulse width modulation method for a display panel having a plurality of scanning electrodes and a plurality of signal electrodes mutually crisscrossing one another, the display driver comprising:
means for changing a frequency of a clock pulse signal for generating a pulse width modulation signal according to a changeable number of color for gradations; and
means for displaying gradations using the changed frequency of the clock pulse signal.

27. A display driver according to claim 26, wherein, when the number of colors is a first number of colors, the clock pulse frequency of the clock pulse signal is set at a first clock pulse frequency, and when the number of colors is a second number of colors that is fewer than the first number of colors, the clock pulse frequency of the clock pulse signal is set at a second clock pulse frequency that is lower than the first clock pulse frequency.

28. A display driving circuit, comprising:
a signal driver comprising a gradation pallet circuit which, based on given switching control signals, converts input gradation data to gradation data having a first number of color gradations by a first gradation pallet circuit or a second number of color gradations by a second gradation pallet circuit;
a frame frequency conversion circuit that switches the frame frequency, based on given switching control signals, to a first frame frequency or to a second frame frequency;
a gradation pattern decoding circuit that performs decoding, wherein the gradation pattern decoding circuit outputs gradation patterns based on gradations corresponding to the converted gradation data, wherein the gradation pattern is data for designating frames that are to be turned on or off in units of frames across a plurality of frames for performing gradation displays; and
a signal electrode driving circuit that drives signal electrodes based on the gradation patterns decoded and output.

29. A display driving circuit, comprising:
means for converting, based on given switching control signals, input gradation data to gradation data having a first number of color gradations by a first gradation pallet circuit or a second number of color gradations;
means for switching a frame frequency, based on the given switching control signals, to a first frame frequency or to a second frame frequency;
means for generating gradation patterns based on gradations corresponding to the converted gradation data, wherein the gradation pattern is data for designating frames that are to be turned on or off in units of frames across a plurality of frames for performing gradation displays; and
means for driving signal electrodes based on the gradation patterns decoded and output.

30. An electrooptic apparatus, comprising:
pixels that are specified by a plurality of scanning electrodes and a plurality of signal electrodes mutually crisscrossing one another;
a display driving circuit, comprising: a signal driver comprising a gradation pallet circuit which, based on given switching control signals, converts input gradation data to gradation data having a first number of color gradations by a first gradation pallet circuit or a second number of color gradations by a second gradation pallet circuit; a frame frequency conversion circuit that switches the frame frequency, based on given switching control signals, to a first frame frequency or to a second frame frequency; a gradation pattern decoding circuit that performs decoding, wherein the gradation pattern decoding circuit outputs gradation patterns based on gradations corresponding to the converted gradation data, wherein the gradation pattern is data for designating frames that are to be turned on or off in units of frames across a plurality of frames for performing gradation displays; and a signal electrode driving circuit that drives signal electrodes based on the gradation patterns decoded and output; and
a scanning driver that drives the scanning electrodes.

31. An electronic apparatus, comprising:
an operation input section for inputting operation information;
an input presence/absence detection section that detects whether operation information is input from the operation input section;
a gradation data generation section that generates input gradation data based on the operation information that is input from the operation input section;
an electrooptic apparatus comprising:
pixels that are specified by a plurality of scanning electrodes and a plurality of signal electrodes mutually crisscrossing one another,
a display driving circuit, comprising: a signal driver comprising a gradation pallet circuit which, based on given switching control signals, converts input gradation data to gradation data having a first number of color gradations by a first gradation pallet circuit or a second number of color gradations by a second gradation pallet circuit; a frame frequency conversion circuit that switches the frame frequency, based on given switching control signals, to a first frame frequency or to a second frame frequency; a gradation pattern decoding circuit that performs decoding, wherein the gradation pattern decoding circuit outputs gradation patterns based on gradations corresponding to the converted gradation data, wherein the gradation pattern is data for designating frames that are to be turned on or off in units of frames across a plurality of frames for performing gradation displays; and a signal electrode driving circuit that drives signal electrodes based on the gradation patterns decoded and output, and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

32. An electrooptic apparatus, comprising:
pixels that are specified by a plurality of scanning electrodes and a plurality of signal electrodes mutually crisscrossing one another;
a display driving circuit, comprising: means for converting, based on given switching control signals, input gradation data to gradation data having a first number of color gradations by a first gradation pallet circuit or a second number of color gradations; means for switching a frame frequency, based on the given switching control signals, to a first frame frequency or to a second frame frequency; means for generating gradation patterns based on gradations corresponding to the converted gradation data, wherein the gradation pattern is data for designating frames that are to be turned on or off in units of frames across a plurality of frames for performing gradation displays; and means for driving signal electrodes based on the gradation patterns decoded and output; and
a scanning driver that drives the scanning electrodes.

33. An electronic apparatus, comprising:
an operation input section for inputting operation information;
an input presence/absence detection section that detects whether operation information is input from the operation input section;
a gradation data generation section that generates input gradation data based on the operation information that is input from the operation input section;
an electrooptic apparatus comprising:
pixels that are specified by a plurality of scanning electrodes and a plurality of signal electrodes mutually crisscrossing one another,
a display driving circuit, comprising: means for converting, based on given switching control signals, input gradation data to gradation data having a first number of color gradations by a first gradation pallet circuit or a second number of color gradations; means for switching a frame frequency, based on the given switching control signals, to a first frame frequency or to a second frame frequency; means for generating gradation patterns based on gradations corresponding to the converted gradation data, wherein the gradation pattern is data for designating frames that are to be turned on or off in units of frames across a plurality of frames for performing gradation displays; and means for driving signal electrodes based on the gradation patterns decoded and output, and
a scanning driver that drives the scanning electrodes; and
a mode setting section that sets a first mode or a second mode for the electrooptic apparatus based on a detection result of the input presence/absence detection section,
wherein the mode setting section sets the first mode when the input presence/absence detection section detects an input of the operation information, and switches from the first mode to the second mode when the input presence/absence detection section does not detect an input of the operation information for a predetermined period.

34. A display driving method, comprising:
converting, based on given switching control signals, input gradation data to gradation data having a first number of color gradations by a first gradation pallet circuit or a second number of color gradations;
switching a frame frequency, based on the given switching control signals, to a first frame frequency or to a second frame frequency;
generating gradation patterns based on gradations corresponding to the converted gradation data, wherein the gradation pattern is data for designating frames that are to be turned on or off in units of frames across a plurality of frames for performing gradation displays; and
driving signal electrodes based on the gradation patterns decoded and output.
